(19) United States
(12) Patent Application Publication
(10) Pub. No.: US 2024/0177032 A1
(43) Pub. Date: May 30, 2024

(54) DETERMINATION OF TRUTHFULNESS OF A NEWS TEXT AND PROBABILITY OF CREATION OF THE TEXT BY ARTIFICIAL INTELLIGENCE BASED ON UNIQUENESS OF OBJECTS

(71) Applicant: Mikhail Dichenko, Saint-Petersburg (RU)

(72) Inventor: Mikhail Dichenko, Saint-Petersburg (RU)

(21) Appl. No.: 18/072,071

(22) Filed: Nov. 30, 2022

(51) Int. Cl. G06N 7/01

(52) U.S. Cl. CPC G06N 7/01

(57) ABSTRACT

A method for determination of truthfulness of a news content item includes receiving a content item. The content item includes textual content. One or more first characteristics of the received content item are determined. The one or more determined first characteristics of the received content item are analyzed. A uniqueness coefficient of the content item is determined based on results of the analysis of the one or more first determined characteristics. A truthfulness coefficient of the content item is determined for one or more second characteristics. An overall truthfulness coefficient of the content item is determined based on a combination of the determined uniqueness coefficient for the one or more determined first characteristics and the determined truthfulness coefficient for the one or more second characteristics.

### TECHNICAL FIELD

The present invention relates to statistical analysis for detecting deception, and more specifically, to determination of truthfulness of a news text and probability of creation of the text by artificial intelligence based on uniqueness of objects.

### BACKGROUND

With the advents of the printing press, typeset, typewriting machines, computer-implemented word processing and mass data storage, the amount of information generated by mankind has risen dramatically and with an ever quickening pace. As a result there is a continuing and growing need to collect and store, identify, track, classify and catalogue for retrieval and distribution this growing sea of information/content. In addition, with the development and widespread deployment of and accessibility to high speed networks, e.g., Internet, there exists a growing need to adequately and efficiently process the growing volume of content available on such networks to assist in decision making. In particular the need exists to quickly process information pertaining to current events to enable informed decision making in light of the effect of current events or related sentiment and in consideration of the effect such events and sentiment may have on the price of traded securities or other offerings.

Advancements in technology, including database mining and management, search engines, linguistic recognition and modeling, provide increasingly sophisticated approaches to searching and processing vast amounts of data and documents, e.g., database of news articles, financial reports, blogs, SEC and other required corporate disclosures, legal decisions, statutes, laws, and regulations, that may affect business performance and, therefore, prices related to the stock, security or fund comprised of such equities. Investment and other financial professionals and other users increasingly rely on mathematical models and algorithms in making professional and business determinations. Especially in the area of investing, systems that provide faster access to and processing of (accurate) news and other information related to corporate performance will be a highly valued tool of the professional and will lead to more informed, and more successful, decision making.

“News analysis” or “news analytics” refers to a broad field encompassing and related to information retrieval, machine learning, statistical learning theory, network theory, and collaborative filtering. News analytics includes the set of techniques, formulas, and statistics and related tools and metrics used to digest, summarize, classify and otherwise analyze sources of information, often public “news” information. An exemplary use of news analytics is a system that digests, i.e., reads and classifies, financial information to determine market impact related to such information while normalizing the data for other effects. News analysis refers to measuring and analyzing various qualitative and quantitative attributes of textual news stories, such as that appear in formal text-based articles and in less formal delivery such as blogs and other online vehicles.

There is a need for a system capable of automatically processing or “reading” news stories and other content available to it and quickly interpreting the content to arrive at a higher understanding of the multimedia content information.

### SUMMARY

In one aspect, a method for determination of truthfulness of a news content item includes receiving a content item. The content item includes textual content. One or more first characteristics of the received content item are determined. The one or more determined first characteristics of the received content item are analyzed. A uniqueness coefficient of the content item is determined based on results of the analysis of the one or more first determined characteristics. A truthfulness coefficient of the content item is determined for one or more second characteristics. An overall truthfulness coefficient of the content item is determined based on a combination of the determined uniqueness coefficient for the one or more determined first characteristics and the determined truthfulness coefficient for the one or more second characteristics.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a content processing apparatus operating in accordance with aspects of the present disclosure.

FIG. 2 is a flowchart of a method for analyzing a received media file based on a selected characteristic, in accordance with aspects of the present disclosure.

FIG. 3 is a flowchart of a method for analyzing distribution of the plurality of objects of the received content item using the selected characteristic function, in accordance with aspects of the present disclosure.

FIG. 4 is a flowchart of a method for determining the difference between the actual and normal density distributions of the selected characteristic, in accordance with aspects of the present disclosure.

FIG. 5 is a flowchart of a method for determining uniqueness of textual content, in accordance with aspects of the present invention.

FIG. 6 is a flowchart of a method for determining a coefficient of truthfulness of a news content item, in accordance with aspects of the present disclosure.

FIG. 7 is a flowchart of a method for increasing the uniqueness of the content item, in accordance with aspects of the present disclosure.

FIG. 8 illustrates a computer system for media file processing and enhancement in accordance with aspects of the present disclosure.

### DETAILED DESCRIPTION

Aspects of the present disclosure are directed to novel techniques of digital content (e.g., text) analysis that determine uniqueness of a content item. Aspects of the present disclosure are further directed to determination of truthfulness of a news text and probability of creation of the text by artificial intelligence based on uniqueness of the content item.

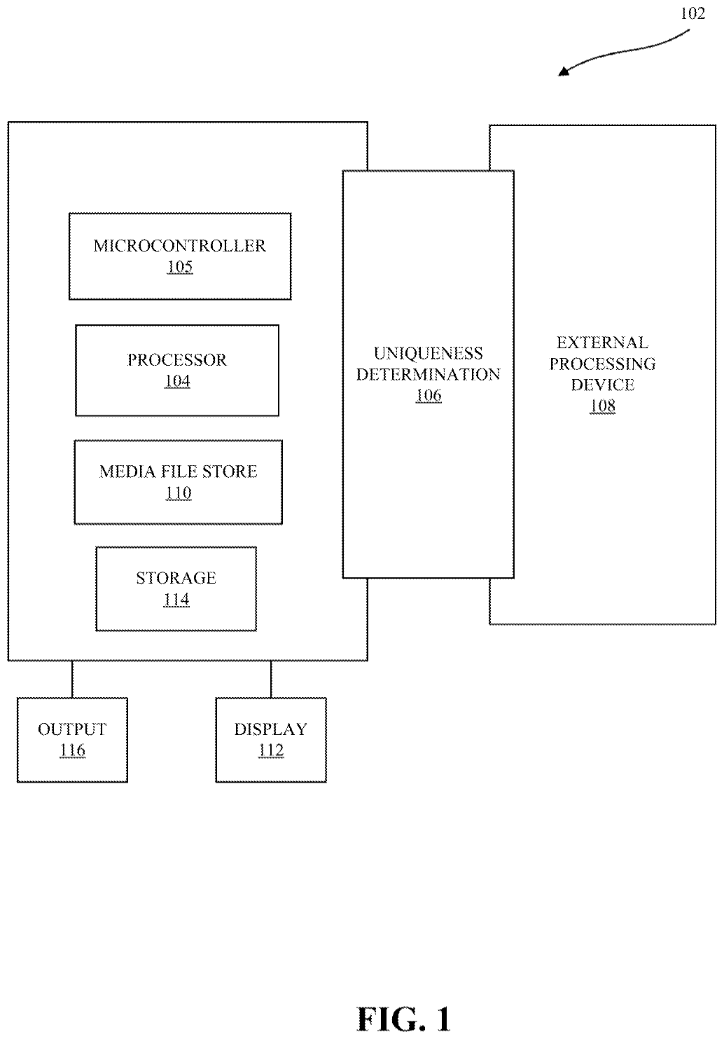

FIG. 1 is a block diagram of a content processing apparatus operating in accordance with aspects of the present disclosure. It will be appreciated that many of the processes implemented in the media file processing device 102 are implemented in or controlled by software operating on a microprocessor, central processing unit, controller, digital signal processor and/or an application specific integrated circuit, collectively depicted as processor 104. All user interface and control of peripheral components such as buttons and display is controlled by a microcontroller 105.

In operation, the processor 104, in response to receiving one or more media files, initiates and controls the file analyzing process. A characteristic function for analyzing the received file is determined, for example, based on a user input. The one or more files analyzed by the media file processing device 102 may be stored in a media file store 110 which may comprise computer memory such a dynamic random-access memory or a non-volatile memory. The file processing device 102 may be equipped with a display 112, such as an LCD, both for displaying analyzed content items and displaying a user interface for control software of the media file processing device 102.

In an aspect, the media processing device 102 further comprises a uniqueness determination module 106. The uniqueness determination module 106 may be arranged for off-line analysis and improvement of analyzed files in an external processing device 108, such as a desktop computer, a mobile device or Internet-of-Things (IOT) device. In this aspect, the processor 104 receives a content item (e.g., a media file) from the media file store 110 and analyses it to determine a uniqueness coefficient of the content item. The analysis is performed as described in the aspects to follow. If, for example, text uniqueness optimization is requested, the uniqueness determination module 106 can modify the text based on the determined uniqueness coefficient. The modified text may be either displayed on display 112, saved on a persistent storage 114 which can be internal or a removable storage such as CF card, SD card or the like, or downloaded to another device via output means 116 which can be tethered or wireless. The uniqueness determination module 106 can be brought into operation either automatically or manually each time a media file is processed. Although illustrated as a separate item, where the uniqueness determination 106 is part of the media file processing device 102, it may be implemented by suitable software on the processor 104. It should be noted that the scope of the invention is not intended to be limited to any particular implementation using technology either now known or later developed in the future.

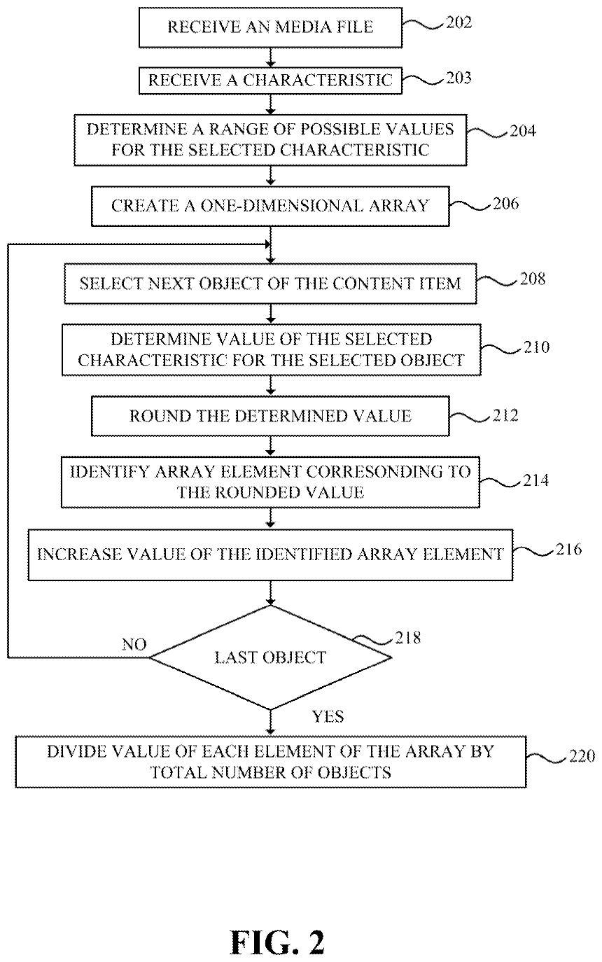

FIG. 2 is a flowchart of a method for analyzing a received media file based on a selected characteristic, in accordance with aspects of the present disclosure. In block 202, the processor 104 receives a media file to be analyzed In one aspect, the processor 104 may receive a media file from the media file store 110. In an aspect, the media file may include a plurality of content items. The plurality of content items may include, but is not limited to, textual content. Textual content may include any amount of text ranging, for example, from a few words to a batch of textual items such as websites, books, articles, or letters In an aspect, the processor 104 may divide the received media file into a plurality of content items.

In block 203, the processor 104 may receive from a user a content item characteristic to be analyzed. In an aspect, the user may enter a desirable characteristic using a Graphical User Interface (GUI) of the file processing device 102, for example. Various characteristics that may be selected by the user for textual content are described below.

In block 204, to calculate the distribution of the analyzed content items (denoted by letter I) using the selected characteristic (denoted by the letter X), the processor 104 may construct a one-dimensional array (block 206). A total number of content items in the set I may be denoted by the letter Q. Elements of the constructed one-dimensional array correspond to discrete values of the selected characteristic—from its minimum possible value (xₘᵢₙ) to the maximum possible value (xₘₐₓ) with an equal interval (“step”), hereinafter denoted by dx. Length of the array constructed in block 206 (the number of elements in the array) is denoted by the letter N hereinafter. The array itself is denoted by the letter P, and the value of array's individual element is denoted by p(i), where i is the ordinal number of the element of the array P. The value of the selected characteristic X, which corresponds to the i-th element of the array P, is denoted as x (i). It is noted that before the start of the described herein content item analysis, all elements of the created array are initialized to 0.

According to an aspect, in block 208, the processor 104 selects next object of the content item to be analyzed. In an aspect, such objects may include, but are not limited to, words, accords, pixels, frames, and the like. Next, in block 210, for the selected object of the content item (denoted below as pix), the value of the selected characteristic (denoted as x (pix)) is calculated by the processor 104. In block 212, the processor 104 rounds the determined value. This rounded value, using rounding to a multiple of the “step,” corresponds to one of the discrete values defined for each of the elements of the constructed array. Continuing with the selected characteristic, for the analyzed object of the received content item, the value of the selected characteristic is calculated. Next, the calculated value is rounded to a multiple of the “step”. When rounding, the processor 104 performs the calculation to the nearest discrete value, and a number located at the same distance from two adjacent discrete values is rounded off to the smallest value. For example, if the calculated value of the characteristic of the analyzed object is 44.5—the processor 104 rounds it to 44. Consequently, the value of the 45th element of the array will be increased by 1, since the array for the selected characteristic is constructed so that the counting starts from 0 with step 1 and the value L=44 falls on the 45th element of the array.

In an aspect, in block 214, the processor 104 identifies the array element corresponding to the rounded value. The term “array element,” as used herein refers to a number of objects with a given characteristic value, divided by the total number of objects (Q). In block 216, the processor 104 increases the value of the identified array element. More specifically, the processor 104 increases by 1 the value of the array element having an index equal to the rounded characteristic value of the analyzed object.

In step 218, the processor 104 determines whether the analyzed object comprises the last object of the content item. In response to determining that the analyzed object is not the last object (decision block 218, “No” branch), the processor 104 repeats blocks 208-216 for all remaining objects of the received content item I. As a result, after processing all the objects of the received content item I (hereinafter, the total number of objects is denoted by the letter Q), the sum of the values of all of the array elements is equal to the number of objects of the received content item I. An element of the array denotes the number of objects with a given value of the characteristic, divided by the total number of objects (i.e., by Q). The concluding step of the content item analyzing procedure for the selected characteristic comprises the normalization of the values of the elements of the constructed array in order to bring it to the classical form, where the total distribution of the analyzed content item objects is equal to 1.

According to an aspect, in response to determining that the last object of the analyzed content item was processed (block 218, “Yes” branch), in block 220, the processor 104 divides the value of each element of the array by the total number of objects in the analyzed content item. It should be noted, the sum of the values of all the elements of the array are equal to 1.

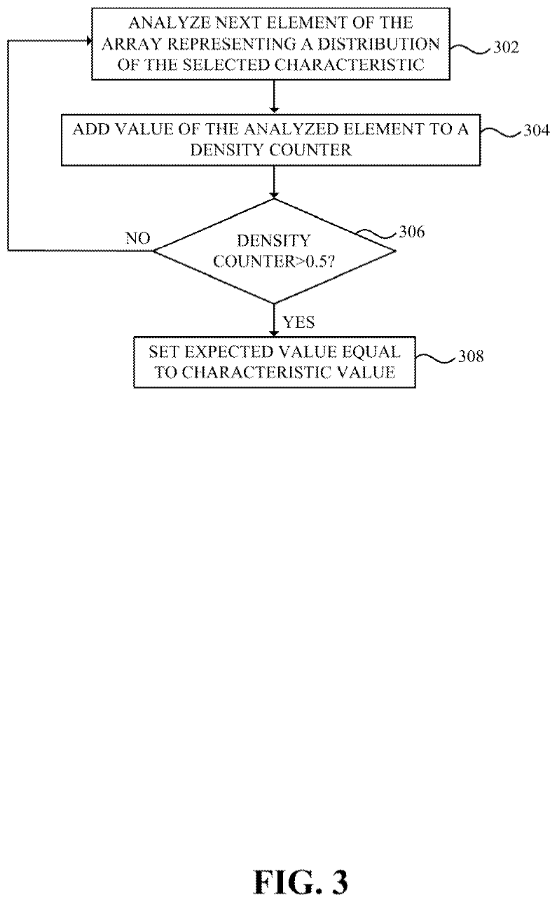

FIG. 3 is a flowchart of a method for analyzing distribution of the plurality of objects of the received content item using the selected characteristic function, in accordance with aspects of the present disclosure. The second stage of the analysis comprises the comparison of the distribution of the selected characteristic X obtained at the first stage (shown in FIG. 2) with the normal distribution, which is described by the formula (1) of the Gaussian function:

$$f ( x ) = \frac{1}{σ \sqrt{2 π}} {e}_{2}^{- \frac{{( x - μ )}^{2}}{2 {σ}^{2}}} \qquad ( 1 )$$

where the parameter μ is the mathematical expectation (average value), median and mode of the distribution, and the parameter σ is the mean-square deviation or sigma (σ² is the variance) of the distribution. The square root of the variance is sigma (standard deviation). The result of comparing the two distributions, as discussed below, enables the processor 104 to perform a quantitative assessment of the uniqueness of the analyzed content item based on the selected characteristic X. It should be noted that in order to reliably compare both density distributions, the compared distributions first need to be reduced to a single scale and coordinate system. According to an aspect, this conformity is achieved by using the expected value and variance of the distribution of the selected characteristic as parameters μ and σ² of the Gaussian function, respectively. The expected value of the distribution of the selected characteristic, considering the discretization used at the first stage, is calculated not with absolute accuracy, but with some approximation, as discussed below.

In block 302, the processor 104 initializes variables utilized for calculation of the expected value In one aspect, the processor 104 initializes variables i and S to 0, where the variable i comprises a counter of the index of the current element of the array representing the distribution of the selected characteristic and the variable S comprises the counter of the total density of the analyzed array elements. In addition, in block 302, the processor 104 analyses the next element of the array representing the distribution of the selected characteristic, where i is the index of the analyzed element of the array.

In an aspect of the present disclosure, in block 304, the processor 104 adds the value of the analyzed element of the array to the counter of total density S (S=p(i)). In block 306, the processor 104 determines if the total density counter is greater than 0.5 (s>0.5). In response to determining that the total density counter does not exceed 0.5 (decision block 306, “No” branch), the processor 104 returns to block 302 and repeats it along with the block 304. In response to determining that the total density counter does exceed 0.5 (decision block 306, “Yes” branch), in block 308, the processor 104 sets the expected value to the value of the selected characteristic corresponding to the analyzed element (μ=X(i)).

The standard deviation of the distribution density array of the selected characteristic X may be calculated by the following formula (2):

σ≡=\sqrt{E[(X−μ)²]}=\sqrt{∫_{-∞}^{+∞}(x−μ)²f(z)dx},

As a result, after the calculation of the dispersion the sigma of the actual distribution (the square root of the variance) also becomes-known.

In an aspect, the processor 104 may determine a uniqueness coefficient (UC) of a content item object using the following formula (3):

UC=(x(i)−μ)²/(σ+N) (3)

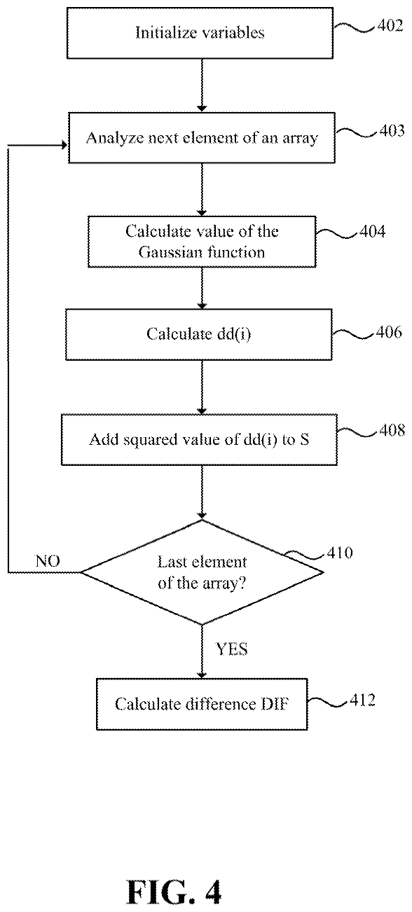

In other words, the processor 104 may determine the uniqueness coefficient by calculating the difference between the value of the object according to the selected characteristic X and the expected value, squared and divided by the sum of the sigma and the range of the selected characteristic (from the minimum value to the maximum value). In an aspect, the processor 104 may substitute the obtained values of the mathematical expectation μ and variance σ as parameters of the Gaussian function, μ and σ², respectively. This operation allows the processor 104 to compare the actual and normal distributions using the difference calculation formula (DIF) according to the algorithm shown in FIG. 4.

FIG. 4 is a flowchart of a method for determining the difference between the actual and normal density distributions of the selected characteristic, in accordance with aspects of the present disclosure In block 402, the processor 104 initializes variables utilized for calculation of the difference between distributions. In one aspect, the processor 104 initializes variables i and S to 0, where the variable i comprises a counter of the index of the current element of the array representing the distribution of the selected characteristic (from xₘᵢₙ to xₘₐₓ) and the variable S comprises the difference counter of all array elements.

In block 403, the processor 104 analyses the next element of the array representing the distribution of the selected characteristic (p(i)), where i is the index of the analyzed element of the array.

According to an aspect, in block 404, the processor 104 calculates the value of the Gaussian function g(i) using formula (1) for x=x(i), where x(i) is the value of the selected characteristic X for the i-th element of the array.

Next, in block 406, the processor 104 calculates the modulus of the difference dd(i) between p(i) and g(i), expressed as a percentage (fractions multiplied by 100). In other words, the processor 104 calculates the difference using the following formula (4):

dd(i)=|p(i)*100−g(i)*100| (4)

According to an aspect, in block 408, the processor 104 adds the squared value of dd(i) calculated in block 406 to the sum of the squared differences of all elements using the following formula (5):

S=S+dd(i)² (5)

In block 410, the processor 104 determines whether the analyzed element comprises the last element of the array. In response to determining that the analyzed element is not the last element (decision block 410, “No” branch), the processor 104 repeats blocks 403-408 for all remaining elements of the array.

According to an aspect, in response to determining that the last element of the array was processed (block 410, “Yes” branch), in block 412, the processor 104 calculates the difference DIF using the following formula (6):

$$DIF = \sqrt{\frac{1}{n} S} , \qquad ( 6 )$$

In an aspect, the processor 104 may calculate the optimality coefficient Op, using the following formula (7).

Op=10/DIF (7)

Next, the processor 104 may determine the derivative (derivative) coefficient of optimality as described below.

The values of dd (i) may be considered by the processor 104 as a set of elements with characteristic Y. Since characteristic Y includes a set of calculated differences, statistically, characteristic Y is different from characteristic X. The processor 104 proportionally normalizes all values of the calculated differences dd (i) in the range from 0 to 10 For example, all values of the calculated differences may be divided into 11 groups. From the entire initial set of differences, the processor 104 determines the largest difference in absolute value denoted hereinafter as Rₘₐₓ.

Based on the determined largest difference, the processor 104 determines a coefficient (k) by which all other values of the differences will be multiplied using the following formula (8):

k=100/Rmax (8)

Further, the processor 104 recalculates all values of dd(i) by multiplying the previously calculated values by k and dividing by 10, as shown in the following formula (9):

dd(i)=dd(i)*k/20. (9)

Formula (9) provides dd(i) values ranging from −5 to 5.

In the next step, the processor 104 rounds up all dd(i) values to an integer and the number 5 is added to them, as shown in the following formula (10).

dd(i)=INT(dd(i))+5 (10)

As a result of applying the formula (10), the maximum difference value will be converted to either 10 if it was positive or 0 if it was negative. In other words, if the original difference value was 0, then it will have a value of 5 in the new set of dd(i) values.

In an aspect, after applying formula (10), the processor 104 creates an array of distribution density consisting of 11 elements (each element corresponds to a value from 0 to 10). The mathematical expectation is set to 6—by the number of the element in which zero (or near zero) differences are concentrated.

In an aspect, the processor 104 uses the generated array of distribution density elements to analyse the received media file based on a selected characteristic (discussed above in conjunction with FIG. 2) and to analyse distribution of the selected characteristic function (discussed above in conjunction with FIG. 3). Based on the results of such analysis, the processor 104 determines a uniqueness coefficient (UC) using formula (3). In an aspect, the processor 104 may also determine an optimality coefficient using the following formula (11) instead of formula (7) discussed above:

Opd=100/DIF (11)

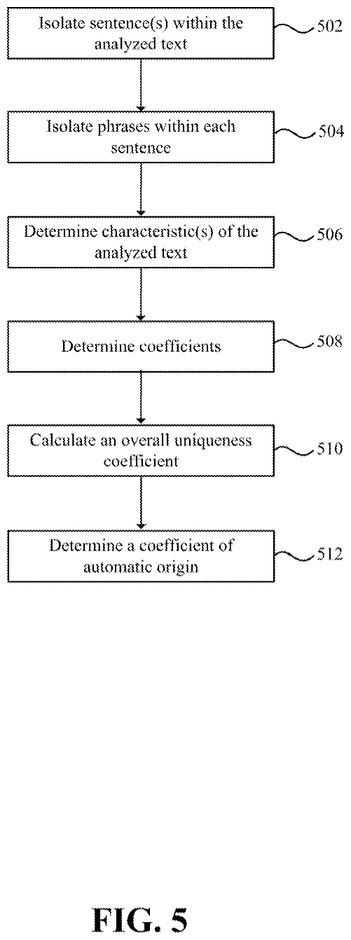

FIG. 5 is a flowchart of a method for determining uniqueness of textual content, in accordance with aspects of the present invention. Generally, to prepare textual content (one or more texts) uniqueness determination, the received text is prepared for analysis first. More specifically, at step 502, the processor 104 isolates one or more sentences within the text to be analyzed. Generally, any text may comprise a set of letters, signs, numbers and spaces. The range of values of this set may include, but is not limited to, the characters of the alphabet, the Arabic numbers from 0 to 9, and other characters. For the purposes of the analysis described herein, the processor 104 may define each unit of such textual information as Le (letter). In any text, there may be any number of spaces between letters Le, but for the purposes of this analysis the plurality of spaces will be counted as one space. The first sentence typically begins with the first Le and ends in a way accepted by the punctuation rules of a particular language of the analyzed textual content. For example, in European languages, sentences usually end with punctuation marks (signs) which include, but are not limited to, the period, the question mark, and the exclamation mark. In other languages, sentences may be identified using similar techniques that conform to grammar of the language of the analyzed textual content. A second sentence in a text starts with the next first Le after the end of the first sentence. Proceeding in this way, the processor 104c may break down the entire text into sentences. In an aspect, the processor 104 may also determine the number of sentences in the text to be analyzed.

At step 504, the processor 104 isolates a plurality of words and phrases within each sentence identified in step 502. For the purposes of the analysis described herein, the processor 104 may define a word as a group of any letters (Le) without any spaces between them. In an aspect, to identify a plurality of words within a sentence, the processor 104 may first convert punctuation marks (signs) that cannot be present within a word into spaces. Continuing with the above example, in European languages, such signs may include, but are not limited to, a comma, a colon, a semicolon, a parenthesis, an ellipsis, and all signs that indicate the end of a sentence. Furthermore, the processor 104 may convert into spaces (replace with spaces) all other signs that cannot, according to the grammatical rules of the language, be present within a single word In an aspect, to identify a plurality of words within a sentence, the processor 104 may next determine the set of words in each sentence as follows: the first word starts with the first Le of the first sentence and ends with the Le that precedes (i.e., located before) a space. The processor 104 identifies all other words within each sentence in a similar way.

In an aspect, a word may be characterized by a number of letters (Le) contained within it. This word length is denoted herein as WL. In an aspect, the processor 104 may consider a phrase to be two, three, four and more neighboring words within a single sentence until a point of absolute uniqueness is reached, as described below. In other words, the phrase may consist of a number of words belonging to a single sentence identified in step 502. The combined concept of a word and a phrase is denoted here as W. W may include any number of words other than zero, i.e. 1, 2, 3 and so on. In an aspect, the number of words in W determines its type. To determine the probability of a specific type of W, the processor 104 may use a monad, dyad and triad shift method, starting from the beginning of the text, to identify a set of copies of a single type of W. If W contains more than one word, the same word may be found in various Ws Upon completion of this process, the processor 104 obtains various unique, fully matching and partially matching copies of W. In an aspect, for the first two forms (unique and fully matching), the processor 104 determines the degree of distribution, the probability of the appearance of each specimen of W in the text, using the following formula (12):

Pwx=Qwx/Qw, (12)

where Pwx is the probability P of the appearance of a specific specimen of W in the text; Qwx is the number of copies of W and Qw is the number of all the copies of W in a given text of a single type.

In an aspect, phrases having identical first words are considered by the processor 104 to be partially matching. For example, partially matching phrases may have phrases that have the same first words. The probability of the partially matching phrases may be calculated using formula (13):

Pwx=Qwx*Cor/Qw, (13)

where Cor is a partial match correction factor having a value ranging from 0.1 to 0.9. Specific value of the partial match correction factor depends on the form, meaning and other parameters of the texts.

In an aspect, the processor 104 assigns each W of each identified sentence its own value of Pwx. If it the Pwx value is calculated for a single word, this probability is denoted P1wx; for two words in a word group, the Pwx value is denoted P2wx, and so on.

In an aspect, to identify a plurality of words within a sentence, the processor 104 may finally determine the maximum number of words in a word group (W). First, the processor 104 calculates the probability for one word. In this case, W consists of one word. If the analyzed text consists of unique words, then no word has a double, or a unique repetition, or an identical clone. In this case, it would be unnecessary for the processor 104 to represent the text in the form of a phrase. Accordingly, in this case, the processor 104 calculates only the P1wx value for one word.

In an aspect, if there is one or more pairs of identical words after the determination of P1wx, the processor 104 calculates the probability for two identical words in the phrase (i.e., P2wx value).

In an aspect, if there is one or more pairs of identical phrases after the determination of P2wx, the processor 104 calculates the probability for three identical words in the phrase (P3wx). The processor 104 continues this process up to a number of words in a phrase for which, in the next step, there is no pair of identical phrases for any number of words in W. For this number of words in W, a point of absolute uniqueness is reached, the probability is not calculated, and the processor 104 stops the process at the last calculated probability Pnwx.

At step 506, the processor 104 determines one or more characteristics of the analyzed text. The first characteristic of a text may be the average length of a word in the text, WLav, which may be calculated using the following formula (14).

WLav=(WL1+WL2+WL3+ . . . +WLn)/n (14)

The second characteristic of a text may be the number of words (1 W), the total number of all 1 W, a characteristic that is denoted as Q1w. The third characteristic may be the average number of words in one sentence (Se). The number of sentences is denoted as Qs. The third characteristic may be denoted using the following formula (15):

Se=Q1w/Qs (15)

The fourth characteristic of a text (and subsequent characteristics, if present) may be the average probability for nW, namely Pnw, which may be calculated using the following formula (16).

Pnw=(Pnw1+Pnw2+Pnw3+ . . . +Pnwx)/x (16),

where x is the number of W of one type.

Accordingly, at step 506, the processor 104 may determine (4+n) characteristics of any text: WLav, Q1w, Se, P1w, P2w . . . Pnw.

At step 508, the processor 104 determines one or more uniqueness coefficients of the analyzed text. In an aspect, using the formula (3) above and methods described in conjunction with FIGS. 2-4, the processor 104 determines the uniqueness coefficient for a selected single text based on the average word length (WLav) characteristic. This uniqueness coefficient is denoted as UCL. The processor 104 may also determine the uniqueness coefficient based on the number of words characteristic. This second uniqueness coefficient is denoted as UCQ. The processor 104 may also determine the uniqueness coefficient based on the third characteristic. This third uniqueness coefficient is denoted as UCS

In an aspect, to determine the uniqueness coefficient for the Pnv characteristic (this uniqueness coefficient is denoted as UCW), the processor 104 may represent a set of texts to be analyzed as a single text. Next, the processor 104 determines the value of Pnw using formula (16) for each analyzed text. It should be noted that there may be two of these values for one text, and there may be more or fewer of Pnw values for another text. In other words, the numbers of characteristics of the various texts based on Pnw values may vary. For each text, the processor 104 calculates the average value according to Pnw. In an aspect, each analyzed text then has only one Pnw value denoted as Pnw-av.

In summary, at step 508, the processor 104 calculates four uniqueness coefficients for a specific text. The first three coefficients (UCL, UCQ, UCS) are positively correlated with uniqueness: the greater their value, the greater is the uniqueness of the text. The fourth coefficient (Pnw-av) is negatively correlated with uniqueness: the higher the coefficient, the lower is the uniqueness.

In an aspect, the processor 104 may calculate an overall uniqueness coefficient using a number of methods of mathematical combination of these coefficients (step 510). For example, the methods for calculating the overall uniqueness coefficient may include, but are not limited to, methods of calculation using any of the following formulas (17)-(21):

UCfin=(UCL+UCq+UCs)/Pnw−av; (17)

UCfin=(UCL*UCq*UCs)/Pnw−av; (18)

UCfin=UCL+UCq+UCs+1/Pnw−av; (19)

UCfin=(UCL+UCq+UCs+(1−Pnw−av))/3; (20)

UCfin=((UCL+UCq+UCs)/3)/Pnw−av. (21)

It should be noted that when the processor 104 calculates the overall uniqueness coefficient using formula (20), the processor 104 may express uniqueness as a percentage using the following formula (22):

LCfin %=UCfin*100 (22)

Advantageously, the method described above in conjunction with FIG. 5 is universal. The described method can be applied to textual content items having a large set of texts, or to textual content items having a small set of texts (e.g., consisting of only two texts).

At step 512, the processor determines a coefficient of automatic origin of a text indicating the probability that the analyzed texts were created by artificial intelligence. It should be noted that the greater the number of texts received at step 502, the higher is the efficiency of the present algorithm for detecting texts created automatically by artificial intelligence. In an aspect, in step 512, the processor 104, after calculating the Ucfin coefficient using formulas (17)-(21), may use the Ucfin coefficients as indicators for comparing texts in terms of the probability of their automatic origin. Texts with a lower value of this coefficient have a high probability of being authored by robot software. The more unique texts (having a higher value of the Ucfin coefficient) are more likely to have been written by humans.

It should be noted that when the processor 104 calculates the overall uniqueness coefficient using formula (20), the processor 104 may express the coefficient of automatic origin of a text as a percentage using the following formula (23):

AII=(1−UCfin)*100%. (23)

The boundary values of this indicator are indicative of origin of the text. For example, if the calculated coefficient is 0%, the corresponding text was definitely created by a human. On the other hand, if the calculated coefficient is 100%, the corresponding text was definitely created by artificial intelligence.

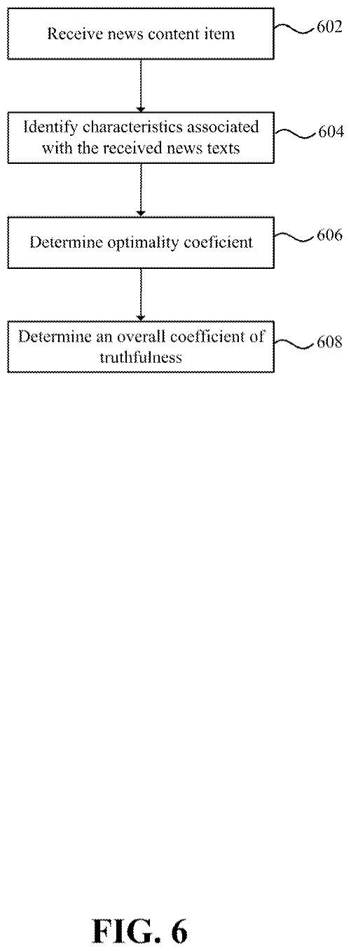

FIG. 6 is a flowchart of a method for determining a coefficient of truthfulness of a news content item, in accordance with aspects of the present disclosure.

In an aspect, at step 602, the processor 104 receives a set of texts (links) associated with particular news content item(s).

At step 604, the processor identifies characteristics associated with the received news texts. In an aspect, all the texts received in step 602 may have a time characteristic associated therewith more specifically, such time characteristic may indicate time of appearance of the corresponding news text, such as, but not limited to, minute, hour, and date. Furthermore, at step 604, the processor may sort the received news texts in chronological order from the earliest to the latest. Next, the processor 104 assigns a value of 0 to the first (earliest) text. The last text, in terms of time, is given a value of 100. The processor 104 divides the time interval between the earliest and the latest news texts into one hundred (100) equal steps along the time scale. All the texts are distributed among these 101 groups. Some groups may have no news texts at all, while other identical groups may receive many news texts. This characteristic of the received news texts is denoted as T (time). Furthermore, at step 604, the processor 104 may determine the number of texts in each group.

Second characteristic that may be used by the processor 104 is denoted as Td (T-delta). For each received news text, starting with the second earliest, there is a corresponding period of time that has elapsed from the preceding text to the present one. The processor 104 may use this period of time as Td characteristic associated with the corresponding news text. In other words, the processor 104 divides the entire set according to this characteristic into one hundred (100) equal steps along the time scale (e.g., 100 minutes). All the texts are distributed among these groups. Furthermore, the processor 104 may determine the number of texts in each group.

Another characteristic that may be used by the processor 104 is denoted as Qrep. In an aspect, Qrep represents the number of replications of the news within the first 100 minutes from its first appearance. Once again, using Qrep characteristic, the processor 104 divides the entire set into one hundred (100) equal steps along the time scale (e.g., 100 minutes). All the texts are distributed among these groups. Furthermore, the processor 104 may determine the number of texts in each group.

Yet another characteristic that may be used by the processor 104 is denoted as Vbites In an aspect, Vbites represents the volume of news in bytes, for example. The processor 104 may use the same distribution method—the lightest text (in terms of volume) may be assigned a value of 0, while the heaviest text may be assigned a value of 100. Once again, using Vbites characteristic, the processor 104 divides the entire set into one hundred (100) equal steps. All the texts are distributed among these groups. Furthermore, the processor 104 may determine the number of texts in each group. It should be noted that the processor 104 may use other characteristics in step 604.

At step 606, the processor 104 determines the optimality coefficient Op and the derived optimality coefficient Opd for all the characteristics identified in step 604 using formulas (7) and (11) described above.

At step 608, the processor 104 determines an overall coefficient of truthfulness (OpTotal). In an aspect, the overall coefficient of truthfulness for each characteristic is determined by a combination of three elements: σ(sigma), Op, Opd. In various aspects, the types of combinations may depend on the type of news, the text, and the area in which it is disseminated. In the non-limiting example illustrated above, the processor 104 calculates a total of 8 coefficients (there may be more of them if a greater number of characteristics is discovered). All of their possible mathematical combinations may provide indication of truthfulness of any news text. For example, the processor 104 may first calculate the following combinations using formulas (24) (27) with respect to first characteristic:

OpTotal₁=Op₁+Opd₁+σ; (24)

OpTotal₁=Op₁; (25)

OpTotal₁=Opd₁; (26)

OpTotal₁=Op₁*Opd₁*σ (27).

Next, the processor 104 may use formulas (24)-(27) to calculate the overall truthfulness coefficient for other characteristics—OpTotal₂, OpTotal₃, and so on. Finally, at step 608, the processor 104 may calculate the overall coefficient of truthfulness for the entire text based on a combination of coefficients (OpTotal₁, OpTotal₂, OpTotal₃, . . . OpTotalₙ) calculated using formulas (24)-(27) and overall uniqueness coefficients calculated using formulas (17)-(21). In an aspect, the processor 104 may calculate the overall truthfulness coefficient using, for example, but not limited to, formulas (28) and (29):

OpTotal=OpTotal₁+OpTotal₂+OpTotal₃+UCfin; (28)

OpTotal=OpTotal₁*OpTotal₂*OpTotal₃*UCfin (29)

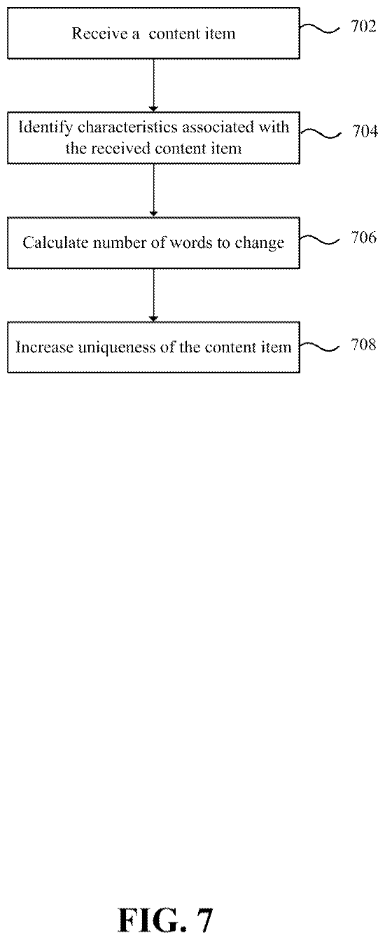

FIG. 7 is a flowchart of a method for increasing the uniqueness of the content item according to a user selected characteristic, in accordance with aspects of the present disclosure.

At step 702, the processor 104 receives a content item. The content item includes at least one textual content. In an aspect, the processor 104 may divide the received media file into a plurality of content items.

At step 704, the processor 104 determines the minimum (Q1wmin) and maximum (Q1wmax) values in the analyzed set of texts received in step 702. In an aspect, the value (Q1wmin−1) may correspond to 100% degree of uniqueness increase in the direction of decreasing the number of Q1w words. The value (Q1wmax+1) may correspond to a 100% increase in uniqueness towards an increase in the number of Q1w words. In an aspect, uniqueness increase may be a configurable parameter. In other words, using this parameter, a user may choose any percentage of increasing uniqueness.

At step 706, based on the uniqueness increase parameter, the processor 104 calculates the required number of words to add or remove (at step 708) to/from a corresponding text. In an aspect, the percentage change may range from 0% to essentially infinity. The values (Q1wmin−1) and (Q1wmax+1) are denoted below as 100Q1w and the uniqueness increase parameter configured by the user is denoted below as Y %. In an aspect, the processor 104 may use the following formula (24).

X=100Q1w*Y %/100% (30)

In an aspect, the processor 104 may perform steps 704 and 706 in a similar fashion using a different characteristic—the average number of words in a sentence, Se.

In yet another aspect, at step 708, the processor 104 may increase uniqueness of the selected file based on the characteristic Pnw-av described above. The method for increasing uniqueness based on the characteristic Pnw-av is demonstrated for a case of a single word in a phrase, i.e. for the characteristic P1w. In this case, for a given set of texts, the processor 104 determines the minimum possible value of P1w, namely a single word that is encountered only once, in one text only. The minimum possible value is denoted P1wmin.

In an aspect, at step 708, the processor 104 replaces all the words in the selected text that have a value higher than P1wmin with synonyms that have a value of P1wmin. In an aspect, to identify synonyms of a particular word, the processor 104 may employ one or more databases of online dictionaries of synonyms. Using such database, the processor 104 may identify synonym words that have not been encountered in the set of texts to be analyzed. If there are no such words, the processor 104 may proceed with replacement using the synonym that has the lowest value of P1w out of all the possible alternative replacements. In an aspect, the processor 104 continues the replacement until the value of the word to be replaced becomes equal to or less than the alternative synonym. In this case, the replacement does not take place. It should be noted that a text with words all having the value P1wmin corresponds to a 100% degree of uniqueness. The user may choose any percentage of increase of uniqueness up to 100%. In other words, the range of percentage change may extend from 0% to 100%. 0% signifies that the text is left unchanged. X % signifies that, out of all the words to be replaced in order to achieve 100% uniqueness, only a number of words required to reach a maximum of X % uniqueness of the text are replaced by the processor 104. It should be noted that the same method may be used for increasing the uniqueness based on phrases having any number of words.

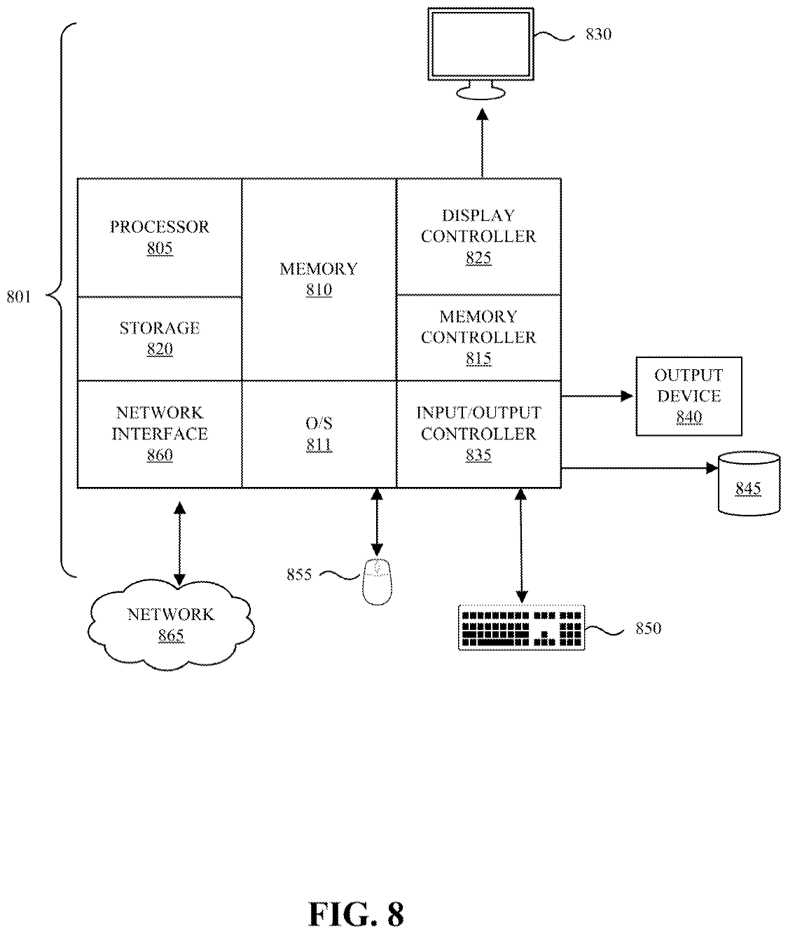

FIG. 8 illustrates a computer system for media file processing and enhancement in accordance with aspects of the present disclosure.

Turning now to FIG. 8, a computer system for media processing and enhancement, such as the media file processing device 102 in FIG. 1, is generally shown in accordance with one or more aspects of the present disclosure. The methods described herein can be implemented in hardware, software (e.g., firmware), or a combination thereof. In one or more exemplary aspects of the present disclosure, the methods described herein are implemented in hardware as part of the microprocessor of a special or general-purpose digital computer, such as a personal computer, workstation, minicomputer, or mainframe computer. The system 800 therefore may include general-purpose computer or mainframe 801 capable of running multiple instances of an 0/S simultaneously.

In one or more exemplary aspects of the present disclosure, in terms of hardware architecture, as shown in FIG. 8, the computer 801 includes one or more processors 805, memory 810 coupled to a memory controller 815, and one or more input and/or output (I/O) devices 840, 845 (or peripherals) that are communicatively coupled via a local input/output controller 835. The input/output controller 835 can be, for example but not limited to, one or more buses or other wired or wireless connections, as is known in the art. The input/output controller 835 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The input/output controller 835 may include a plurality of sub-channels configured to access the output devices 840 and 845. The sub-channels may include fiber-optic communications ports.

The processor 805 is a hardware device for executing software, particularly that stored in storage 820, such as cache storage, or memory 810. The processor 805 can be any custom made or commercially available processor, a central processing unit (CPU), an auxiliary processor among several processors associated with the computer 801, a semiconductor based microprocessor (in the form of a microchip or chip set), a macroprocessor, or generally any device for executing instructions.

The memory 810 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 810 may incorporate electronic, magnetic, optical, and/or other types of storage media. Note that the memory 810 can have a distributed architecture, where various components are situated remote from one another, but can be accessed by the processor 805.

The instructions in memory 810 may include one or more separate programs, each of which comprises an ordered listing of executable instructions for implementing logical functions. In the example of FIG. 8, the instructions in the memory 810 a suitable operating system (OS) 811. The operating system 811 essentially controls the execution of other computer programs and provides scheduling, input-output control, file and data management, memory management, and communication control and related services.

In accordance with one or more aspects of the present disclosure, the memory 810 may include multiple logical partitions (LPARs) each running an instance of an operating system. The LPARs may be managed by a hypervisor, which may be a program stored in memory 810 and executed by the processor 805.

In one or more exemplary aspects, a conventional keyboard 850 and mouse 855 can be coupled to the input/output controller 835. Other output devices such as the I/O devices 840, 845 may include input devices, for example but not limited to a printer, a scanner, microphone, and the like. Finally, the I/O devices 1140, 845 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 800 can further include a display controller 825 coupled to a display 830.

In one or more exemplary aspects, the system 800 can further include a network interface 860 for coupling to a network 865. The network 865 can be an IP-based network for communication between the computer 801 and any external server, client and the like via a broadband connection. The network 865 transmits and receives data between the computer 801 and external systems, such as the external processing device 108 of FIG. 1. In an exemplary aspect, network 865 can be a managed IP network administered by a service provider. The network 865 may be implemented in a wireless fashion, e.g., using wireless protocols and technologies, such as WiFi, WiMax, etc. The network 865 can also be a packet-switched network such as a local area network, wide area network, metropolitan area network, Internet network, or other similar type of network environment. The network 865 may be a fixed wireless network, a wireless local area network (LAN), a wireless wide area network (WAN) a personal area network (PAN), a virtual private network (VPN), Intranet or other suitable network system and includes equipment for receiving and transmitting signal.

If the computer 801 is a PC, workstation, intelligent device or the like, the instructions in the memory 810 may further include a basic input output system (BIOS) (omitted for simplicity). The BIOS is a set of essential software routines that initialize and test hardware at startup, start the OS 811, and support the transfer of data among the hardware devices. The BIOS is stored in ROM so that the BIOS can be executed when the computer 801 is activated.

When the computer 801 is in operation, the processor 805 is configured to execute instructions stored within the memory 810, to communicate data to and from the memory 810, and to generally control operations of the computer 801 pursuant to the instructions.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following a portable computer diskette, a hard disk, a random access memory (RAM), a read-only memory (ROM), an erasable programmable read-only memory (EPROM or Flash memory), a static random access memory (SRAM), a portable compact disc read-only memory (CDROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Various aspects of the present disclosure are described herein with reference to the related drawings. Alternative aspects can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various aspects of the present disclosure will be presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determination of truthfulness of a news content item, the method comprising:
receiving a content item, wherein the content item includes textual content;
determining one or more first characteristics of the received content item;
analyzing the one or more determined first characteristics of the received content item;
determining a uniqueness coefficient of the content item based on results of the analysis of the one or more first determined characteristics;
determining a truthfulness coefficient of the content item for one or more second characteristics; and
determining an overall truthfulness coefficient of the content item based on a combination of the determined uniqueness coefficient for the one or more determined first characteristics and the determined truthfulness coefficient for the one or more second characteristics.

2. The method of claim 1, wherein determining the one or more first characteristic functions comprises:
identifying a plurality of sentences within the received content item;
isolating one or more phrases within each of the plurality of sentences; and
determining probability of appearance of the one or more phrases within the received content item.

3. The method of claim 2, wherein the one or more first characteristic functions comprises at least one of: an average length of a word in the content item, a total number of words in the content item, an average number of words in a sentence of the content item; and a probability for identical words within the one or more phrases.

4. The method of claim 3, wherein determining the uniqueness coefficient comprises determining at least one of: determining a first uniqueness coefficient based on the average length of the word; determining a second uniqueness coefficient based on the total number of words; determining a third uniqueness coefficient based on the average number of words in a sentence; and determining a fourth uniqueness coefficient based on the probability of identical words.

5. The method of claim 4, wherein determining the uniqueness coefficient further comprises determining an overall uniqueness coefficient of the content item based on at least one of the first uniqueness coefficient, second uniqueness coefficient, third uniqueness coefficient, and the fourth uniqueness coefficient.

6. The method of claim 5, wherein determining the uniqueness coefficient of the content item comprises determining the uniqueness coefficient based on the one or more determined first characteristic functions.

7. The method of claim 1, wherein determining a truthfulness coefficient of the content item comprises determining the truthfulness coefficient based on a determined optimality coefficient and a determined derived optimality coefficient.

8. The method of claim 1, wherein the one or more second characteristic functions comprises at least one of: a time characteristic, a text volume, a number of replications within a predetermined period of time.

9. The method of claim 1, wherein determining the truthfulness coefficient comprises determining a sum of truthfulness coefficients for each of the one or more second characteristics and the determined uniqueness coefficient.

10. The method of claim 1, wherein determining the truthfulness coefficient comprises determining a product of truthfulness coefficients for each of the one or more second characteristics and the determined uniqueness coefficient.

11. A system for determination of truthfulness of a news content item, the system comprising: at least one processor; and at least one memory storing computer-executable instructions, wherein the at least one processor is configured to access the at least one memory and execute the computer-executable instructions to:
receiving a content item, wherein the content item includes textual content;
determine one or more first characteristics of the received content item;
analyze the one or more determined first characteristics of the received content item;
determine a uniqueness coefficient of the content item based on results of the analysis of the one or more first determined characteristics;
determine a truthfulness coefficient of the content item for one or more second characteristics; and
determine an overall truthfulness coefficient of the content item based on a combination of the determined uniqueness coefficient for the one or more determined first characteristics and the determined truthfulness coefficient for the one or more second characteristics.

12. The system of claim 11, wherein the at least one processor configured to determine the one or more first characteristic functions is further configured to:
identify a plurality of sentences within the received content item;
isolate one or more phrases within each of the plurality of sentences; and
determine probability of appearance of the one or more phrases within the received content item.

13. The system of claim 12, wherein the one or more first characteristic functions comprises at least one of: an average length of a word in the content item, a total number of words in the content item, an average number of words in a sentence of the content item; and a probability for identical words within the one or more phrases.

14. The system of claim 13, wherein the at least one processor configured to determine the uniqueness coefficient is further configured to determine at least one of: determine a first uniqueness coefficient based on the average length of the word; determine a second uniqueness coefficient based on the total number of words; determine a third uniqueness coefficient based on the average number of words in a sentence; and determine a fourth uniqueness coefficient based on the probability of identical words.

15. The system of claim 14, wherein the at least one processor configured to determine the uniqueness coefficient is further configured to determine an overall uniqueness coefficient of the content item based on at least one of the first uniqueness coefficient, second uniqueness coefficient, third uniqueness coefficient, and the fourth uniqueness coefficient.

16. The system of claim 15, wherein the at least one processor configured to determine the uniqueness coefficient of the content item is further configured to determine the uniqueness coefficient based on the one or more determined first characteristic functions.

17. The system of claim 11, wherein the at least one processor configured to determine the truthfulness coefficient of the content item is further configured to determine the truthfulness coefficient based on a determined optimality coefficient and a determined derived optimality coefficient.

18. The system of claim 11, wherein the one or more second characteristic functions comprises at least one of: a time characteristic, a text volume, a number of replications within a predetermined period of time.

19. The system of claim 1, wherein the at least one processor configured to determine the truthfulness coefficient is further configured to determine a sum of truthfulness coefficients for each of the one or more second characteristics and the determined uniqueness coefficient.

20. The system of claim 11, wherein the at least one processor configured to determine the truthfulness coefficient is further configured to determine a product of truthfulness coefficients for each of the one or more second characteristics and the determined uniqueness coefficient.
